(19) United States
(12) Patent Application Publication
(10) Pub. No.: US 2007/0017235 A1
(43) Pub. Date: Jan. 25, 2007

(54) Energy-saving fuzzy control method and fuzzy control machine in central air conditioner

(76) Inventors: Xiaobing Cai, Guiyang (CN); Lin Guo, Guiyang (CN); Lixin Yuan, Guiyang (CN); Qianyang Zhiang, Guiyang (CN)

Correspondence Address: CARSTENS & CAHOON, LLP, P O BOX 802334, DALLAS, TX, 75380, US

(21) Appl. No.: 10/558,654

(22) PCT Filed: Sep. 1, 2003
(86) PCT No.: PCT/CN03/00729

§ 371 Date: Nov. 29, 2005

(30) Foreign Application Priority Data
Jun. 13, 2003 (CN) 03135207.3

(51) Int. Cl. G05D 23/32; F25D 17/06; G01M 1/38

(52) U.S. Cl. 62/157; 62/190; 700/278; 700/276

(57) ABSTRACT

The present invention disclosures a central air-conditioning energy conservation fuzzy control method and fuzzy controller, including: micro-computer, input circuit, output circuit, protective circuit, communication interface circuit, power and micro-computer control program, it is based on the human (expert)'s rich experience and thought to form a fuzzy rule to make inference and judgment, it imitate the expert to resolve the complicated problems in the air-conditioner operation. The precise mathematical model has no need to be established for the controlled central air-conditioner, but only the fuzzy description is needed to realize the controlling. This kind of controlling is more conform the complexity, dynamics and fuzziness of the central air-conditioner, it makes the controlling simple and could realize a best central air-conditioning system operation—safety, comfort and energy conservation.

### FIELD OF THE INVENTION

The present invention relates to an intelligent controller of central air-conditioning energy conservation control system, especially relates to a central air-conditioning system energy conservation fuzzy controlling method and device.

### BACKGROUND OF THE INVENTION

Currently, along the worldwide energy shortage, the energy conservation controlling system design and application are even more emphasized in the central air-conditioning system design and operation.

In the recent years, with the appearance of high-power electronic parts, it promotes miniaturization and practicality of transducers, in order to cut down the energy waste of central air-conditioning system, the transducers are used to control the air-conditioning system's water pump and fan, by the collection of the water system pressure difference and temperature and make use of the programmable controller (PLC), the water pump and fan are controlled in way of the PI (proportional, integral) adjustment or the PID (proportional, integral, differential) adjustment to realize an energy conservation. Owing to the fact that the PLC could only realize a simple logic function, it's also called the programmable logic controller. The PLC control method has a certain energy conservation effect, and the PI controlling or PD controlling has a long history with simple principle and easy operation, strong adaptability. But its shortage, however, is as follows:

Firstly, in case the most important project parameter Kₚ (proportional coefficient), T_{I} (integration time constant) and T_{d} (differential time constant) of PI or PID regulator are confirmed, they are fixed unchangeably if nobody adjusts them, they couldn't be adjusted automatically with the change of controlled parameters, i.e. once the project parameters are setup, the same parameters are used for various operation conditions. In fact, the central air-conditioning system is a kind of time-dependent dynamic system, its operation conditions are affected by the season, climate, temperature, person flow rate etc, it is changeable momentarily and always stands in the fluctuation. In this way, the optimal controlling effect couldn't be obtained with the static parameter control method.

Secondly, the PLC could only realize a simple controlling function of single parameter (temperature or pressure) with somehow better effects in the single parameter industrial production process controlling, in control of, however, the complicated central air-conditioner of more parameters, non-linearity, time-dependent and strong inner-parameter coupling, the central air-conditioning system would be easily brought to oscillate, and the controlling temperature fluctuates within wide range, and the system couldn't arrive the stabilize state of set value for a long time, this not only affects the stability of system, but also reduces the comfort of air-conditioning effect.

The central air-conditioning system is a kind of more variable, time-dependent complicated system, its process factors have a bad relationship of non-linearity, large delay and strong coupling. No mater the traditional PID controlling or various algorithms of modern controlling theory, a better controlling effect is hard to be realized with this kind of system.

For the complicated central air-conditioner with more parameters, non-linearity, time-dependent and strong inner-parameter coupling, the precise mathematical model couldn't describe it or the model is either too complicated or more rough, the classical mathematics with the main feature of accuracy is hard to be successful to this controlling problem.

A skilled operator or technician, however, may manually control the system by his experience, eye, ear and the like with satisfactory controlling effects. E.g. the operator may start the refrigerator (or turn on another refrigerator) if the temperature in the building is higher than set value in summer; otherwise, if the temperature is lower than set value, he may stop the refrigerator (or turn off another refrigerator). According to the temperature deviation, if the temperature is more higher than the set value, more refrigerators are to be started to lower the temperature fast. The above “higher”, “more”, “fast” etc are all fuzzy concepts. Therefore, the operator's observation and judgment are, in practice, a fuzziness and fuzzy calculation process.

### CONTENTS OF THE INVENTION

The present invention is purposed to provide a fuzzy control method and device for the central air-conditioning system energy conservation controlling by making use of the modern fuzzy controlling technology, if the man's operational experience, knowledge and technique are induced as a series of rules and stored into the computer, quantifying them by use of the fuzziness collection theory to make the controller to imitate the man's operational strategy and realize a central air-conditioner intelligent controlling to overcome the defect and shortage of current technology; The computer, input circuit, output circuit, protective circuit, communication interface circuit, power circuit and its control software etc compose the fuzzy controller of the central air-conditioning energy conservation controlling system, and it provides an advanced energy conservation device for the modern central air-conditioning system.

The purpose of this invention is realized as follows: the fuzzy controller includes micro computer, input circuit, output circuit, protective circuit, communication interface circuit, power circuit and micro computer control program, the micro computer realizes a fuzzy control algorithm through the control program; the input circuit makes use of AD7896 single-chip computer to compose the A/D and level convert circuit; the output circuit makes use of P87LPC768 single-chip computer to compose the D/A and level convert circuit; the protective circuit makes use of P87LPC764 single-chip computer; the communication interface circuit is a full-duplex serial communication interface; the power circuit includes the voltage stabilized circuit, filter circuit, over-current protection, over-voltage protection.

The fuzzy control method, including the steps of data collection, fuzziness quantum process, fuzziness inference, non-fuzziness process, output etc, the concrete process is as follows:

(1) Data Collection and Model Initialization

In the stage of data collection and model initialization, the fuzzy controller collects the current flow, current flow-back water temperature, current water supply temperature of the freezing water through the sensor, and obtains the corresponding signals through the input circuit, and based on the pre-given freezing water set flow, freezing water flow-back water set temperature and freezing water supply set temperature, the micro-computer calculates the temperature difference deviation and temperature difference deviation change rate in terms of the pre-given formulas.

(2) Temperature Difference Deviation Variable Fuzziness

In stage of temperature difference deviation variable fuzziness, according to the temperature difference deviation calculated from the data collection and model initialization stage, the micro-computer makes use of the completed program to calculate the temperature difference deviation affiliation and temperature difference deviation fuzzy value.

(3) Temperature Difference Deviation Change Rate Fuzziness

In stage of temperature difference deviation change rate fuzziness, according to the temperature difference deviation change rate calculated from the data collection and model initialization stage, the micro-computer makes use of the completed program to calculate the temperature difference deviation change rate fuzzy value and temperature difference deviation change rate affiliation.

(4) Fuzziness Inference

The temperature difference deviation fuzzy value calculated from the temperature difference deviation variable fuzziness stage and the temperature difference deviation change rate fuzzy value calculated from the temperature difference deviation change rate fuzziness stage are used as the input parameters, the micro-computer makes use of the completed program to check and calculate the fuzzy control value in the fuzziness rule list.

(5) Fuzziness Value Definition Process

In this stage, using the temperature difference deviation affiliation calculated from the temperature difference deviation variable fuzziness stage, the temperature difference deviation change rate fuzzy value calculated from the temperature difference deviation change rate fuzziness stage and the fuzzy control value calculated from the fuzziness inference, the micro-computer makes use of the completed program and the given formula and checking list to calculate the control value.

(6) Correction Step

In the correction step, using the terminal maximum value and system delay of the variable calculated from the various stages above, the micro-computer makes use of the completed program and the given calculation formula to calculate the correction value.

(7) Output Process

In stage of the output process, according to the control value calculated from the fuzziness value definition process stage and the correction value calculated from the correction step, the micro-computer makes use of the given formula to program and calculate the frequency converter frequency control value, and transfer the control value to the central air-conditioning executor through the output circuit to control the central air-conditioner operation.

The present invention has the following merits compared with the traditional technology:

Firstly, it is based on the fuzziness rule of human (expert)'s rich experience and thought to make inference and judgment, and imitate the technical expert's deciding process to resolve the complicated problems resolved by expert. The accurate mathematical model for the controlled object is not needed, and it only needs a fuzzy description to realize the controlling. This kind of controlling is more meet the complexity, dynamics and fuzziness of the central air-conditioner, the control is thus simple and the controlling precision is achieved.

Secondly, in the fuzzy controlling, the fuzziness logic language variable and its fuzziness relationship are introduced for the fuzziness inference, the forbidden area could be controlled by computer which is no possible otherwise in the precise model controlling, a precise controlling effect is thus obtained on basis of the precise model controlling. Thus the fuzzy controlling has a better energy conservation effect than the PID controlling.

Thirdly, with the precise control function of fuzzy controlling, the controlled frequency converting & speed adjustment of the central air-conditioning water system realizes the practical operation of variable temperature difference, variable pressure difference and variable flow, the controlling system has a better following and change ability, it could adjust the operation parameters self-suitably according to the controlled dynamic process property identification to get an optimal controlling effect. Obviously, the fuzzy controlling is changeable, and it is the changeable property that the complicated non-linearity relationship between the input and output is established to effect the intelligent controlling, and it is the complicated non-linearity that the fuzzy controlling could control the controlled central air-conditioning's non-linearity, time-dependent and non-definiteness etc, and realize the best central air-conditioning system operation—safety, comfort and energy conservation.

The present invention may be practiced widely and could be co-operated with the new central air-conditioning system, it could also replace the traditional controlling mode to make technical modification to the present central air-conditioning system, and to provide an advanced energy conservation control device to reduce the energy waste, advance the usage of energy and lower the central air-conditioning operation cost.

In the present invention, apart from the higher efficiency of energy conservation of central air-conditioning system, the controlled frequency converting & speed adjustment may realize a smooth starting & stop of the high-powered system pump and fan to reduce the shock and mechanical wearing, the device noise, the device trouble and prolong the device usage life. Thus, it has a tremendous economic & society benefit.

### BRIEF DESCRIPTION OF THE APPENDED DRAWINGS

FIG. 1 is a block diagram showing an embodiment of a fuzzy controller according to the present invention.

FIG. 2 is a flow chart showing an embodiment of a fuzzy controlling method according to the present invention.

### DESCRIPTION OF THE EMBODIMENTS

(1) Fuzzy Controller

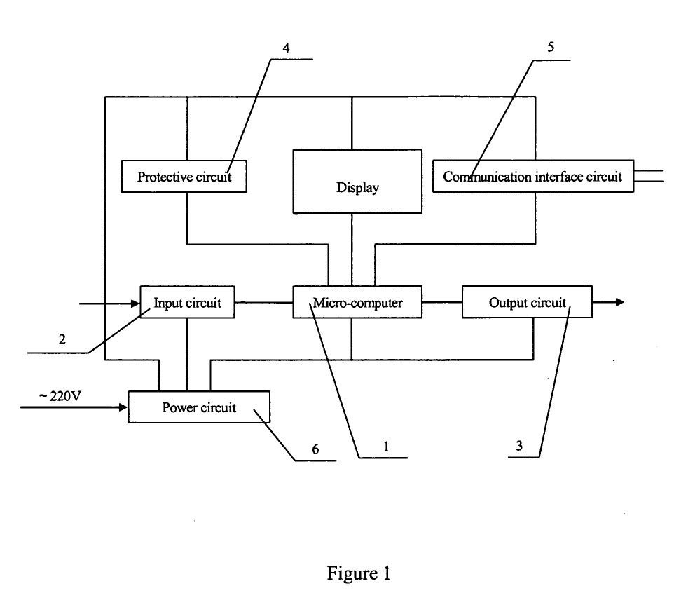

Refer to FIG. 1, the fuzzy controller according to the present invention includes: micro-computer 1, input circuit 2, output circuit 3, protective circuit 4, communication interface circuit 5 and power circuit 6, the control software is installed in the micro-computer 1.

The micro-computer 1 makes use of the Intel P4 processor with 1.8 GHz, 256 MB memory and 40 GB hard disk. The fuzzy control algorithm is realized by the control software.

The display device supports the pixel of 1024×768 above and the enhanced color of 16 bits above.

In the input circuit 2, the AD7896 single-chip computer is used to compose the A/D and level convert circuit. The fuzzy controller receives the signals from the controlled object through the output circuit.

In the output circuit 3, the P87LPC768 single-chip computer is used to compose the D/A and level convert circuit. The fuzzy controller transmits the output signal to the executor through the output circuit to control the object to be controlled.

In the protective circuit 4, the P87LPC764 single-chip computer is used to provide the micro-computer with a “Watchdog” function, in case of the computer “deadlock” caused by various interferences, the protective circuit would start again automatically, and save the control operation information automatically to make the computer recover to its original working state.

The communication interface circuit 5 is a 485 full-duplex serial communication interface measured up the international standard with the biggest communication distance of 1200 m, it could transmit the information with the controlled equipment in the central air-conditioning system, transmit the control program command, and receive the controlled equipment operation information to realize an intellectual controlling.

The power circuit 6 consists of voltage stabilized circuit, filter circuit, over-current protection and over-voltage protection circuit etc, and provides the micro-computer, input circuit, output circuit, display and protective circuit etc with the power.

(2) Software Part

The core of the fuzzy control software is the fuzzy control rule and fuzziness inference. In the fuzzy control rule, the human (expert)'s operation experience and thought are summed up as a series of condition sentences, i.e. the control rule, thereby to get a fuzziness relationship. Moreover, in the fuzziness inference, the human (expert)'s control actions are summed up to educe a fuzziness algorithm rule.

The operational principle of the fuzzy controller is as follows:

The computer receives deviation value of the controlled value and change rate of the deviation value from the input terminal through interrupted sampling, they are all precise values, and the fuzziness set is obtained after the fuzziness process, the application of fuzziness inference rule makes the fuzziness decision by the fuzziness set and fuzzy control rule to get the corresponding fuzzy control set, and the precise control value is obtained to control the controlled object after the non-fuzziness (or definition) process.

Then, the computer interrupts to wait for the second data sampling and conducts the second controlling . . . The fuzzy controlling of the controlled object is thus realized by repeating the above process.

The fuzzy controlling consists of the following four steps:

(1) obtain the input variable of the fuzzy controller according to the present data sampling;

(2) change the input variable exact value to the fuzzy value;

(3) calculate the control value (fuzzy value) by the fuzziness inference according to the input fuzzy value and fuzzy control rule;

(4) calculate the precise control value by the control value (fuzzy value).

As see from the above, the intelligent control based on fuzziness logic—fuzzy control, is different from the traditional control theory based on precise model. The traditional control constitution is: comparison—calculation—control—execution, moreover the intelligent fuzzy control constitution is: identification—inference—decision—execution. It is clear that the fuzzy control is based on the controlled dynamic process property identification, and it is the control that based on the knowledge, experience inference and intelligent decision.

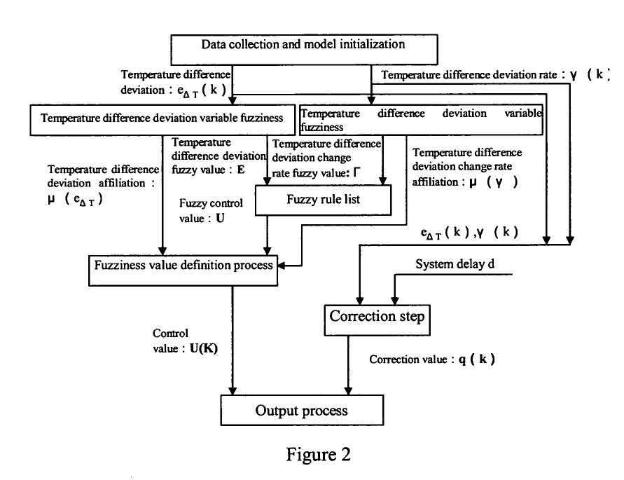

Refer to FIG. 2, the fuzzy control rule algorithm of the present invention central air-conditioning energy conservation controlling system fuzzy controller is as follows:

(1) Data Collection and Model Initialization

In stage of data collection and model initialization, the fuzzy controller collects the freezing water current flow Q, current flow-back water temperature T_{back}, current water supply temperature T_{supply} through the sensor, and obtains the corresponding signals through the input circuit, and the micro-computer calculates the temperature difference deviation eΔ_{T}(k) and temperature difference deviation change rate γ (k) by the pre-set formula according to the pre-given freezing water set flow Q_{rating}, freezing water flow-back water set temperature T_{back rating} and freezing water supply set temperature T_{suppy rating}.

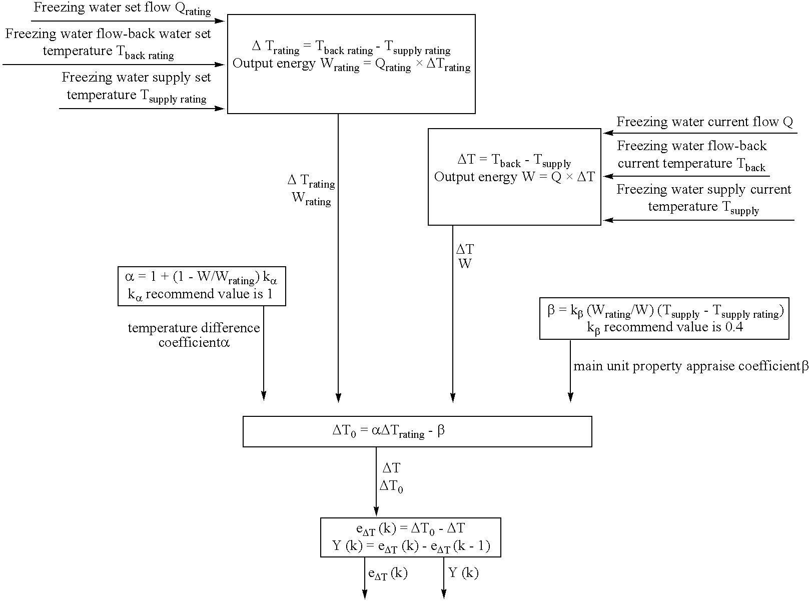

(2) Temperature Difference Variable Fuzziness

In stage of temperature difference deviation variable fuzziness, using the temperature difference deviation eΔ_{T}(k) calculated from the data collection and model initialization stage, the micro-computer makes use of the completed program (checking the list) to calculate the temperature difference deviation affiliation μ (eΔ_{T}) and the temperature difference deviation fuzzy value E.

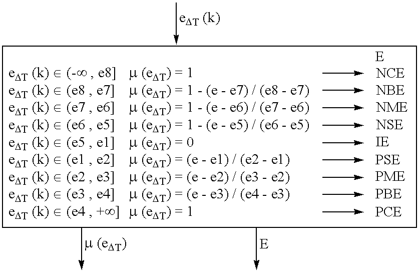

(3) Temperature Difference Deviation Change Rate Fuzziness

In stage of temperature difference deviation change rate fuzziness, using the temperature difference deviation change rate deviation γ (k) calculated from the data collection and model initialization stage, the micro-computer makes use of the completed program and the list to calculate the temperature difference deviation change rate fuzzy value Γ and the temperature difference deviation change rate affiliation μ (γ).

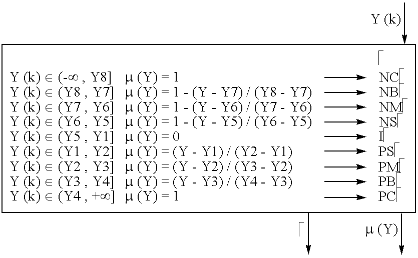

(4) Fuzziness Inference

Make use of the temperature difference deviation fuzzy value E calculated from the temperature difference deviation variable fuzziness stage and the temperature difference deviation change rate fuzzy value Γ calculated from the temperature difference deviation change rate fuzziness stage as the input parameters, the micro-computer makes use of the completed program to check and calculate the fuzzy control value U in the fuzzy rule list.

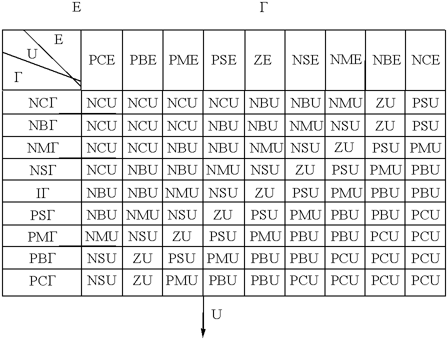

(5) Fuzziness Value Definition Processor

In this stage, using the temperature difference deviation affiliation μ (eΔ_{T}) calculated from the temperature difference deviation variable fuzziness stage, the temperature difference deviation change rate fuzzy value μ (γ) calculated from the temperature difference deviation change rate fuzziness stage, and the fuzzy control value U calculated from the fuzziness inference, the micro-computer makes use of the completed program to calculate the control value U(k) by the given formula and list.

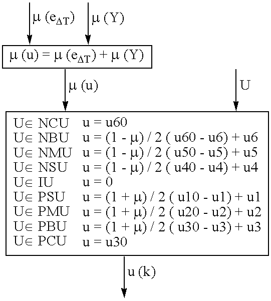

(6) Correction Step

In the correction step, make use of the terminal maximum value a, b and system delay d of the variable eΔ_{T}(k), γ (k), eΔ_{T}(k) and eΔ_{T}(k-1) calculated from the various stages above, the micro-computer calculates the correction value q(k) according to the completed program and the given calculation formula.

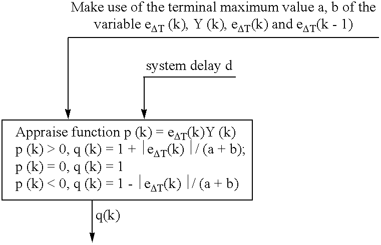

(7) Output Process

In the output process stage, according to the control value U(k) calculated from the fuzziness value definition process stage, and the correction value q(k) calculated from the correction step, the micro-computer calculates the frequency converter's frequency control value f(k) in terms of the given formula based computer program, and the control value is transmitted to the central air-conditioning executor to control the central air-conditioning operation through the output circuit.

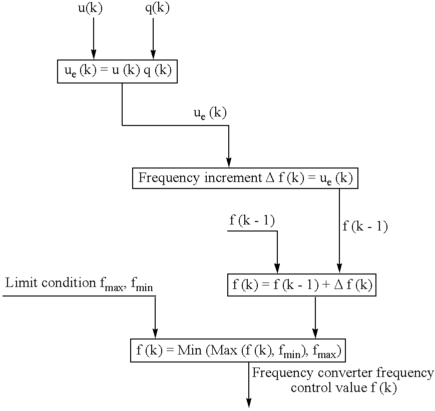

We claim:

1. A central air-conditioning energy conservation fuzzy controller, including: micro-computer (1), input circuit (2), output circuit (3), protective circuit (4), communication interface circuit (5), power circuit (6) and micro-computer control program, characterized in that: the micro-computer (1) realizes a fuzzy control algorithm through the control program; the input circuit (2) makes use of AD7896 single-chip computer to compose the A/D and level convert circuit; the output circuit (3) makes use of P87LPC768 single-chip computer to compose the D/A and level convert circuit; the protective circuit (4) makes use of P87LPC764 single-chip computer; the communication interface circuit (5) is a full-duplex serial communication interface; the power circuit (6) includes the voltage stabilized circuit, filter circuit, over-current protection, over-voltage protection.

2. A central air-conditioning energy conservation fuzzy control method, characterized in that: including the steps of data collection, fuzziness quantum process, fuzziness inference, non-fuzziness process, output etc, the concrete process is as follows:
(1) Data collection and model initialization
In the stage of data collection and model initialization, the fuzzy controller collects the current flow, current flow-back water temperature, current water supply temperature of the freezing water through the sensor, and obtains the corresponding signals through the input circuit, and based on the pre-given freezing water set flow, freezing water flow-back water set temperature and freezing water supply set temperature, the micro-computer calculates the temperature difference deviation and temperature difference deviation change rate in terms of the pre-given formulas.
(2) Temperature difference deviation variable fuzziness
In stage of temperature difference deviation variable fuzziness, according to the temperature difference deviation calculated from the data collection and model initialization stage, the micro-computer makes use of the completed program to calculate the temperature difference deviation affiliation and temperature difference deviation fuzzy value.
(3) Temperature difference deviation change rate fuzziness
In stage of temperature difference deviation change rate fuzziness, according to the temperature difference deviation change rate calculated from the data collection and model initialization stage, the micro-computer makes use of the completed program to calculate the temperature difference deviation change rate fuzzy value and temperature difference deviation change rate affiliation.
(4) Fuzziness inference
The temperature difference deviation fuzzy value calculated from the temperature difference deviation variable fuzziness stage and the temperature difference deviation change rate fuzzy value calculated from the temperature difference deviation change rate fuzziness stage are used as the input parameters, the micro-computer makes use of the completed program to check and calculate the fuzzy control value in the fuzziness rule list.
(5) Fuzziness value definition process
In this stage, using the temperature difference deviation affiliation calculated from the temperature difference deviation variable fuzziness stage, the temperature difference deviation change rate fuzzy value calculated from the temperature difference deviation change rate fuzziness stage and the fuzzy control value calculated from the fuzziness inference, the micro-computer makes use of the completed program and the given formula and checking list to calculate the control value.
(6) Correction step
In the correction step, using the terminal maximum value and system delay of the variable calculated from the various stages above, the micro-computer makes use of the completed program and the given calculation formula to calculate the correction value.
(7) Output process
In stage of the output process, according to the control value calculated from the fuzziness value definition process stage and the correction value calculated from the correction step, the micro-computer makes use of the given formula to program and calculate the frequency converter frequency control value, and transfer the control value to the central air-conditioning executor through the output circuit to control the central air-conditioner operation.

3. The central air-conditioning energy conservation fuzzy control method according to claim 2, characterized in that: the calculation formula of the temperature difference deviation and temperature difference deviation change rate in the said data collection and model initialization step is:

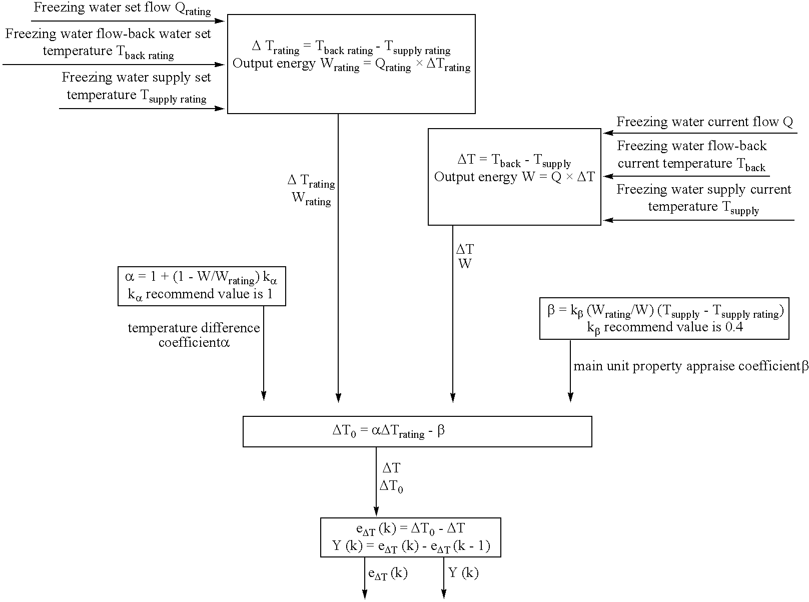

4. The central air-conditioning energy conservation fuzzy control method according to claim 2, characterized in that: the calculation formula of the temperature difference deviation affiliation and temperature difference deviation fuzzy value in the temperature difference deviation variable fuzziness step is:

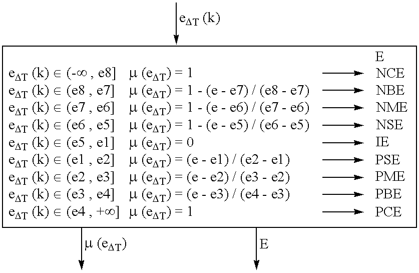

5. The central air-conditioning energy conservation fuzzy control method according to claim 2, characterized in that: the calculation formula of the temperature difference deviation change rate fuzzy value and temperature difference deviation change rate affiliation in the temperature difference deviation change rate fuzziness step is:

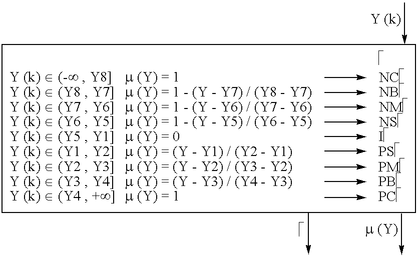

6. The central air-conditioning energy conservation fuzzy control method according to claim 2, characterized in that: the fuzziness rule list of fuzzy control value calculated in the fuzziness inference step is:

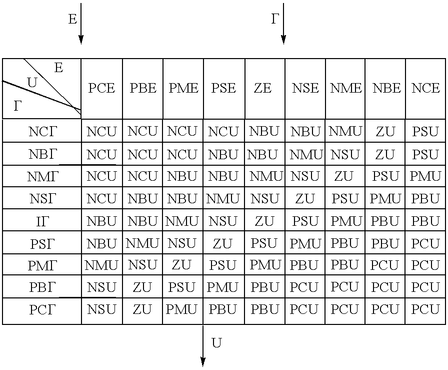

7. The central air-conditioning energy conservation fuzzy control method according to claim 2, characterized in that: the calculation formula of the control value in the fuzziness value definition process step is:

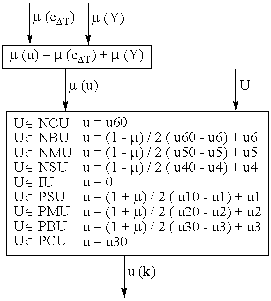

8. The central air-conditioning energy conservation fuzzy control method according to claim 2, characterized in that: the calculation formula of the correction value in the correction step is:

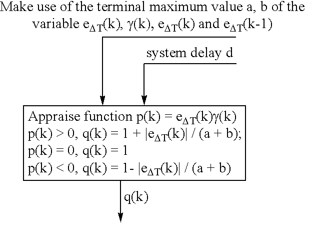

9. The central air-conditioning energy conservation fuzzy control method according to claim 2, characterized in that: the calculation formula of the frequency converter frequency control value in the output process step is: [chemical structure]
